(19) United States
(12) Patent Application Publication
(10) Pub. No.: US 2022/0251293 A1
(43) Pub. Date: Aug. 11, 2022

(54) YELLOWING RESISTANT POLYESTER AND METHOD FOR MANUFACTURING THE SAME

(71) Applicant: CHANG CHUN PLASTICS CO., LTD., Taipei City (TW)

(72) Inventors: Ching-Jui HUANG, Taipei City (TW); Ping-Chieh WANG, Taipei City (TW)

(73) Assignee: CHANG CHUN PLASTICS CO., LTD., Taipei City (TW)

(21) Appl. No.: 17/649,431

(22) Filed: Jan. 31, 2022

(30) Foreign Application Priority Data
Feb. 3, 2021 (TW) 110104076

(51) Int. Cl. C08G 63/60; C08G 63/85; C08G 63/87

(52) U.S. Cl. CPC C08G 63/605; C08G 63/87; C08G 63/85

(57) ABSTRACT

A polyester and a method for manufacturing polyester are provided. The polyester comprises one or more repeating units derived from polyols and one or more repeating units derived from polybasic acids and contains phosphorus and a metal element, wherein one or more repeating units derived from polyols include a repeating unit derived from tricyclodecane dimethanol, the weight ratio of the phosphorus to the metal element ranges from 0.05 to 5.00, and the metal element is selected from the group consisting of Ti, Sn, Sb, Ge, Mn, Zn, Ca, Co, Pb, Al, Zr, and combinations thereof.

### CLAIM FOR PRIORITY

This application claims the benefit of Taiwan Patent Application No. 110104076 filed on Feb. 3, 2021, the subject matters of which are incorporated herein in their entirety by reference.

### BACKGROUND OF THE INVENTION

### Field of the Invention

The present application provides a polyester, especially a tricyclodecane dimethanol (TCDDM) polyester having high optical transmittance and yellowing resistance, and a method for manufacturing the polyester.

### Descriptions of the Related Art

Polyester is widely used in the field of food contacts, packaging materials, food containers and the like. It is known that tricyclodecane dimethanol (TCDDM) can be used in the preparation of polyester to improve the mechanical strength and heat resistance of the prepared polyester. However, the polyester materials still have poor yellowing resistance.

### SUMMARY OF THE INVENTION

In view of the aforementioned technical problem, the present application provides a polyester with high mechanical strength, high heat resistance, high transmittance and excellent yellowing resistance, and a method for manufacturing the same. The polyester of the present application can be used in the field of food contacts, packaging materials, food containers, moldings, commercial and household ware, electronics, the casing of devices, luminaires, outdoor signs, personal care appliances, sporting goods, toys and the like, but the applications of the polyester of the present application are not limited thereto.

Therefore, an objective of the present application is to provide a polyester, which comprises one or more repeating units derived from polyols and one or more repeating units derived from polybasic acids and contains phosphorus and a metal element, wherein the one or more repeating units derived from polyols include a repeating unit derived from tricyclodecane dimethanol, the weight ratio of the phosphorus to the metal element ranges from 0.05 to 5.00, and the metal element is selected from the group consisting of Ti, Sn, Sb, Ge, Mn, Zn, Ca, Co, Pb, Al, Zr, and combinations thereof.

In some embodiments of the present application, the amount of the repeating unit derived from tricyclodecane dimethanol is 10 mol % or more based on the total moles of the one or more repeating units derived from polyols.

In some embodiments of the present application, the phosphorus is phosphorus(III), phosphorus(V), or a combination thereof.

In some embodiments of the present application, the metal element is selected from the group consisting of Ti, Sn, Ge, Sb, and combinations thereof.

In some embodiments of the present application, the amount of the phosphorus is 3 ppm to 200 ppm based on the total weight of the polyester, and the amount of the metal element is 5 ppm to 500 ppm based on the total weight of the polyester.

In some embodiments of the present application, the one or more repeating units derived from polyols further comprises one or more repeating units represented by

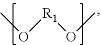

wherein R₁ is a C₂-C₁₇ linear or branched hydrocarbyl group.

In some embodiments of the present application, the one or more repeating units derived from polybasic acids are selected from the repeating units represented by

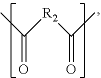

wherein R₂ is a C₄-C₁₆ hydrocarbyl group.

Another objective of the present application is to provide a method for manufacturing the aforementioned polyester, which comprises polymerizing a polyol component with a polybasic acid component under the presence of the phosphorus and the metal element, wherein the polyol component comprises tricyclodecane dimethanol and has a carbonyl value of less than 0.15 mg KOH/g.

To render the above objectives, technical features and advantages of the present application more apparent, the present application will be described in detail with reference to some specific embodiments hereinafter.

### BRIEF DESCRIPTION OF THE DRAWINGS

Not applicable.

### DESCRIPTION OF THE PREFERRED EMBODIMENTS

Hereinafter, some specific embodiments of the present application will be described in detail. However, the present application may be embodied in various embodiments and the scope of the inventions sought to be protected should not be limited to the embodiments described in the specification.

Unless it is additionally explained, the expressions “a,” “the,” or the like recited in the specification (especially in the appended claims) should include both the singular and the plural forms.

Unless it is additionally explained, while describing constituents in a solution, mixture or composition in the specification, the amount of each constituent is calculated based on the dry weight, i.e., regardless of the weight of the solvent.

In the specification, a tricyclodecane dimethanol (TCDDM) polyester is referred to as a polyester containing a repeating unit derived from TCDDM, and the polyester may or may not further comprise one or more repeating units derived from other polyols (such as diols). In some embodiments of the present application, the polyester of the present application comprises a repeating unit derived from TCDDM and one or more repeating units derived from other polyols (such as diols).

The efficacy of the present application particularly lies in that the polyester has a high heat resistance and high transmittance as well as excellent yellowing resistance. The polyester of the present application and the manufacturing method thereof are described below in detail.

### 1. Polyester

The polyester of the present application contains phosphorus and a metal element. The backbone chain of the polyester comprises one or more repeating units derived from polyols and one or more repeating units derived from polybasic acids or is substantially consisting of or consisting of one or more repeating units derived from polyols and one or more repeating units derived from polybasic acids. The detailed descriptions of the components of the polyester of the present application are provided below.

### 1.1. Repeating Units Derived from Polyols

The polyester of the present application comprises one or more repeating units derived from polyols, wherein the one or more repeating units derived from polyols include a repeating unit derived from tricyclodecane dimethanol (TCDDM). In some embodiments of the present application, the repeating unit derived from tricyclodecane dimethanol have a structure of

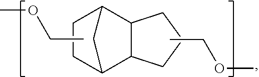

such as

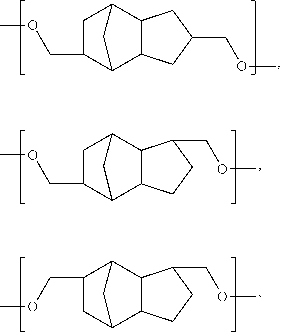

or two or more of the foregoing, but the present application is not limited thereto. While not being bound by theory, it is believed that the repeating unit derived from tricyclodecane dimethanol can provide the efficacy of improving the mechanical strength and heat resistance of the polyester.

In some embodiments of the present application, based on the total moles of the one or more repeating units derived from polyols, the amount of the repeating unit derived from tricyclodecane dimethanol is preferably 10 mol % or more, specifically 15 mol % to 90 mol %, and more specifically 20 mol % to 80 mol %. For example, based on the total moles of the one or more repeating units derived from polyols, the amount of the repeating unit derived from tricyclodecane dimethanol can be 21 mol %, 22 mol %, 23 mol %, 24 mol %, 25 mol %, 26 mol %, 27 mol %, 28 mol %, 29 mol %, 30 mol %, 31 mol %, 32 mol %, 33 mol %, 34 mol %, 35 mol %, 36 mol %, 37 mol %, 38 mol %, 39 mol %, 40 mol %, 41 mol %, 42 mol %, 43 mol %, 44 mol %, 45 mol %, 46 mol %, 47 mol %, 48 mol %, 49 mol %, 50 mol %, 51 mol %, 52 mol %, 53 mol %, 54 mol %, 55 mol %, 56 mol %, 57 mol %, 58 mol %, 59 mol %, 60 mol %, 61 mol %, 62 mol %, 63 mol %, 64 mol %, 65 mol %, 66 mol %, 67 mol %, 68 mol %, 69 mol %, 70 mol %, 71 mol %, 72 mol %, 73 mol %, 74 mol %, 75 mol %, 76 mol %, 77 mol %, 78 mol %, or 79 mol %, or within a range between any two of the values described herein. In some embodiments of the present application, based on the total moles of the repeating units derived from polyols, the amount of the repeating unit derived from tricyclodecane dimethanol is 30 mol % to 80 mol %, and more specifically, 40 mol % to 70 mol %. When the amount of the repeating unit derived from the tricyclodecane dimethanol is within the aforementioned ranges, the polyester provided thereby may have excellent mechanical strength and heat resistance.

Optionally, the polyester of the present application may further comprise one or more repeating units derived from polyols other than TCDDM. For example, the polyester of the present application may further comprise one or more repeating units derived from diols other than TCDDM. The diols can be such as C₂-C₇ diols, and examples of C₂-C₇ diols include but are not limited to ethylene glycol, propylene glycol, 2-methyl-1,3-propanediol, 2,2-dimethyl-1,3-propanediol, 2-butyl-2-ethyl-1,3-propanediol, butylene glycol, pentylene glycol, 3-methyl-1,5-pentanediol, hexylene glycol, heptylene glycol, octylene glycol, 1,4-cyclohexanedimethanol, pentacyclo[6.5.1.1³⁻⁶.0²⁻⁷.0⁹⁻¹³]pentadecane dimethanol, and pentacyclo[9.2.1.1⁴⁻⁷.0²⁻¹⁰.0³⁻⁸]pentadecane dimethanol. In some embodiments of the present application, the polyester of the present application further comprises one or more repeating units derived from C₂-C₉ linear or branched diols or 1,4-cyclohexanedimethanol, wherein examples of the C₂-C₉ linear or branched diols include but are not limited to ethylene glycol, propylene glycol, 2-methyl-1,3-propanediol, 2,2-dimethyl-1,3-propanediol, 2-butyl-2-ethyl-1,3-propanediol, butylene glycol, pentylene glycol, 3-methyl-1,5-pentanediol, hexylene glycol, heptylene glycol, and octylene glycol. In some embodiments of the present application, the polyester of the present application further comprises one or more repeating units derived from C₂-C₆ linear diols, wherein examples of the C₂-C₆ linear diols include but are not limited to ethylene glycol, propylene glycol, butylene glycol, pentylene glycol, and hexylene glycol. In some embodiments of the present application, the polyester of the present application further comprises one or more repeating units derived from C₂-C₄ linear diols, wherein examples of the C₂-C₄ linear diols include but are not limited to ethylene glycol, propylene glycol, and butylene glycol. In the appended Examples, the polyester of the present application further comprises a repeating unit derived from ethylene glycol.

Accordingly, in some embodiments of the present application, the one or more repeating units derived from polyols further comprises one or more repeating units represented by

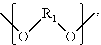

wherein R₁ is a C₂-C₁₇ linear or branched hydrocarbyl group or a C₃-C₁₇ cyclic or bridged polycyclic hydrocarbyl group. Examples of the C₂-C₁₇ linear or branched hydrocarbyl group include C₂-C₁₇ linear or branched alkylene, and examples of the C₃-C₁₇ cyclic or bridged polycyclic hydrocarbyl group include C₃-C₁₇ cyclic or bridged polycyclic alkyl. Examples of the C₂-C₁₇ linear or branched alkylene include but are not limited to ethylene, propylene, butylene, pentylene, hexylene, heptylene, octylene,

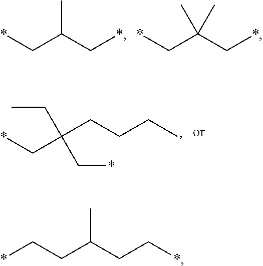

wherein * indicates the bonding site. Examples of the C₃-C₁₇ cyclic or bridged polycyclic alkyl include but are not limited to cyclohexanedimethyl

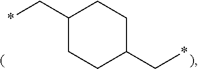 [SMILES: *CC1CCC(C*)CC1]

pentacyclo[6.5.1.1³-6.0²⁻⁷.0⁹⁻¹³]pentadecane dimethyl

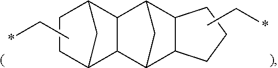

and pentacyclo[9.2.1.1⁴⁻⁷.0²⁻¹⁰.0³⁻⁸]pentadecane dimethyl

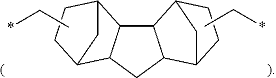

In some embodiments of the present application, the one or more repeating units derived from polyols further comprise one or more repeating units represented by

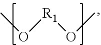

wherein R₁ is a C₂-C₉ linear or branched alkylene or a cyclic alkyl, such as ethylene, propylene, butylene, pentylene, hexylene, heptylene, octylene,

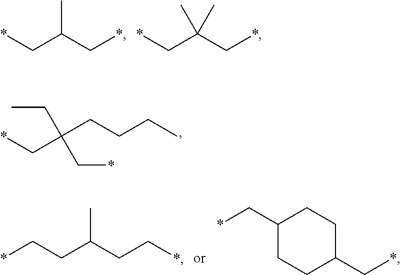

wherein * indicates the bonding site. In some embodiments of the present application, the one or more repeating units derived from polyols further comprise one or more repeating units represented by

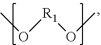

wherein R₁ is a C₂-C₆ linear or branched alkylene, such as ethylene, propylene, butylene, pentylene, or hexylene. In some embodiments of the present application, the one or more repeating units derived from polyols further comprise one or more repeating units represented by

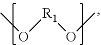

wherein R₁ is a C₂-C₄ linear or branched alkylenes, such as ethylene, propylene, or butylene. In the appended Examples, the repeating units derived from polyols further comprise a repeating unit represented by

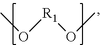

wherein R₁ is ethylene.

### 1.2. Repeating Units Derived from Polybasic Acids

The polyester of the present application comprises one or more repeating units derived from polybasic acids. Examples of one or more repeating units derived from polybasic acids include repeating units derived from dibasic acids. Examples of the dibasic acids include but are not limited to C₆-C₁₈ dicarboxylic acids, such as adipic acid, sebacic acid, phthalic acid, isophthalic acid, terephthalic acid, and naphthalene dicarboxylic acid.

In some embodiments of the present application, the one or more repeating units derived from polybasic acids are selected from the repeating units represented by

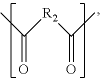

wherein R₂ is a C₄-C₁₆ hydrocarbyl group, including C₄-C₁₆ linear or branched hydrocarbyl groups and C₄-C₁₆ cyclic or polycyclic hydrocarbyl groups. Examples of the C₄-C₁₆ linear or branched hydrocarbyl groups include C₄-C₁₆ linear or branched alkylene groups. Examples of the C₄-C₁₆ cyclic or polycyclic hydrocarbyl groups include C₄-C₁₆ cyclic or polycyclic aryl groups. Examples of the C₄-C₁₆ linear or branched alkylene groups include but are not limited to butylene and octylene. Examples of the C₄-C₁₆ cyclic or polycyclic aryl group include but are not limited to phenylene and naphthalene. In some embodiments of the present application, the one or more repeating units derived from polybasic acids further comprise one or more repeating units represented by

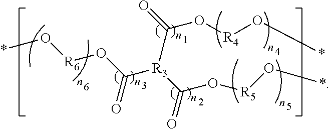

R₃ is a C₃-C₂₀ hydrocarbyl group; R₄, R₅, and R₆ are independently a C₁-C₆ hydrocarbyl group; n₁, n₂, n₃, n₄, n₅, and n₆ are independently 0 or 1; and * indicates the bonding site. The amount of the repeating units represented by

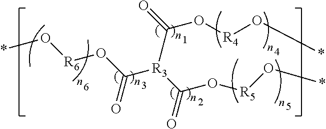

is no more than 0.7% based on the total number of the repeating units of the polyester.

### 1.3. Phosphorus

The polyester of the present application comprises phosphorus as an essential component, and the weight ratio of the phosphorus to the metal element described below ranges from 0.05 to 5.00. For example, the weight ratio of the phosphorus to the metal element described below can be 0.06, 0.07, 0.08, 0.09, 0.10, 0.15, 0.20, 0.25, 0.30, 0.35, 0.40, 0.45, 0.50, 0.55, 0.60, 0.65, 0.70, 0.75, 0.80, 0.85, 0.90, 0.95, 1.00, 1.05, 1.10, 1.15, 1.20, 1.25, 1.30, 1.35, 1.40, 1.45, 1.50, 1.55, 1.60, 1.65, 1.70, 1.75, 1.80, 1.85, 1.90, 1.95, 2.00, 2.05, 2.10, 2.15, 2.20, 2.25, 2.30, 2.35, 2.40, 2.45, 2.50, 2.55, 2.60, 2.65, 2.70, 2.75, 2.80, 2.85, 2.90, 2.95, 3.00, 3.05, 3.10, 3.15, 3.20, 3.25, 3.30, 3.35, 3.40, 3.45, 3.50, 3.55, 3.60, 3.65, 3.70, 3.75, 3.80, 3.85, 3.90, 3.95, 4.00, 4.05, 4.10, 4.15, 4.20, 4.25, 4.30, 4.35, 4.40, 4.45, 4.50, 4.55, 4.60, 4.65, 4.70, 4.75, 4.80, 4.85, 4.90, or 4.95, or within a range between any two of the values described herein. If the weight ratio of the phosphorus to the metal element is lower than the lower limit of the forementioned range, the yellowing resistance of the prepared polyester is poor. If the weight ratio of the phosphorus to the metal element is higher than the upper limit of the aforementioned range, the polymerization efficiency becomes poor, and the polyester would not have acceptable molecular weight, which results in poor mechanical strength.

Phosphorus in the polyester of the present application can be in elemental form or oxidized form. That is, the oxidation number of the phosphorus can be 0 or higher than 0. In some embodiments of the present application, the phosphorus is phosphorus(III). In some embodiments of the present application, the phosphorus is phosphorus(V). In some embodiments of the present application, the phosphorus is a combination of phosphorus(III) and phosphorus(V). It is surprisingly found that polyester containing phosphorus(III) has better transmittance and yellowing resistance. Therefore, the phosphorus in the polyester of the present application preferably comprises phosphorus(III).

The source of the phosphorus in the polyester of the present application is not particularly limited and includes any phosphorus-containing components. For example, at least one of phosphoric acid (H₃PO₄), sodium dihydrogen phosphate (H₂NaPO₄), and trimethyl phosphate (TMPA) can be added to the raw materials for manufacturing polyester as the source of phosphorus(V). At least one of tris(nonylphenyl) phosphite (such as the product under the model number of AO 1178, available from Chang Chun Petrochemical Co., Ltd., Taiwan), tris(2,4-di-tert-butylphenyl) phosphite (such as the product under the model number of 2112, available from Chang Chun Petrochemical Co., Ltd., Taiwan), tetrakis(2,4-di-tert-butylphenyl)-4,4′-biphenyl diphosphonite (such as the product under the model number of PEPQ, available from Clariant Corporation, Switzerland), dioctadecyl pentaerythritol bis(phosphite) (such as the product under the model number of PEP-8T, available from Chang Chun Petrochemical Co., Ltd., Taiwan), and bis(2,6-di-tert-butyl-4-methylphenyl)pentaerythritol diphosphite (such as the product under the model number of PEP-36, available from Adeka Fine Chemical Corporation, Japan) can be added to the raw materials for manufacturing polyester as the source of phosphorus(III). But the present application is not limited thereto.

In the polyester of the present application, the amount of the phosphorus can be adjusted depending on needs. In some embodiments of the present application, based on the total weight of the polyester, the amount of the phosphorus in the polyester is preferably 3 ppm to 200 ppm, more specifically 5 ppm to 150 ppm. For example, based on the total weight of the polyester, the amount of the phosphorus in the polyester can be 10 ppm, 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 95 ppm, 100 ppm, 105 ppm, 110 ppm, 115 ppm, 120 ppm, 125 ppm, 130 ppm, 135 ppm, 140 ppm, or 145 ppm, or within a range between any two of the values described herein. In the appended Examples, the amount of the phosphorus in the polyester is 15 ppm to 75 ppm based on the total weight of the polyester.

### 1.4. Metal Element

The polyester of the present application comprises a metal element as an essential component, wherein the metal element is selected from the group consisting of Ti, Sn, Sb, Ge, Mn, Zn, Ca, Co, Pb, Al, Zr, and combinations thereof, preferably selected from the group consisting of Ti, Sn, Ge, Sb, and combinations thereof. In addition, the ratio of the metal and phosphorus in the polyester is as described above.

The metal element in the polyester of the present application can be in elemental form or oxidized form. That is, the oxidation number of the metal element can be 0 or higher than 0.

The source of the metal element is not particularly limited and may come in a variety of components containing the metal element, such as an oxide or a salt containing the metal element. For example, titanium butoxide (such as the product under the model number of TBT, available from Dorf & Ketal) or titanium isopropoxide (such as the product under the model number of AQ-5000, available from Borica) can be added to the raw materials for manufacturing polyester as the source of titanium, butyltin tris(2-ethylhexanoate) can be added to the raw materials for manufacturing polyester as the source of tin, antimony oxide (Sb₂O₃) or antimony acetate (Sb(OAc)₃) can be added to the raw materials for manufacturing polyester as the source of antimony, and germanium oxide (GeO₂) can be added to the raw materials for manufacturing polyester as the source of germanium, but the present application is not limited thereto.

In the polyester of the present application, the amount of the metal element can be adjusted depending on needs. In some embodiments of the present application, based on the total weight of the polyester, the amount of the metal element in the polyester is 5 ppm to 500 ppm, more specifically 8 ppm to 200 ppm. For example, based on the total weight of the polyester, the amount of the metal element in the polyester can be 9 ppm, 10 ppm, 11 ppm, 12 ppm, 13 ppm, 14 ppm, 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 95 ppm, 100 ppm, 105 ppm, 110 ppm, 115 ppm, 120 ppm, 125 ppm, 130 ppm, 135 ppm, 140 ppm, 145 ppm, 150 ppm, 155 ppm, 160 ppm, 165 ppm, 170 ppm, 175 ppm, 180 ppm, 185 ppm, 190 ppm, or 195 ppm, or within a range between any two of the values described herein. In the appended Examples, the amount of the metal element in the polyester is 8 ppm to 200 ppm based on the total weight of the polyester.

In some embodiments of the present application, the metal element is Sn, and the amount of Sn in the polyester based on the total weight of the polyester is 30 ppm to 300 ppm, more specifically 50 ppm to 200 ppm. For example, based on the total weight of the polyester, the amount of Sn in the polyester can be 55 ppm, 60 ppm, 65 ppm, 70 ppm, 75 ppm, 80 ppm, 85 ppm, 90 ppm, 95 ppm, 100 ppm, 105 ppm, 110 ppm, 115 ppm, 120 ppm, 125 ppm, 130 ppm, 135 ppm, 140 ppm, 145 ppm, 150 ppm, 155 ppm, 160 ppm, 165 ppm, 170 ppm, 175 ppm, 180 ppm, 185 ppm, 190 ppm, or 195 ppm, or within a range between any two of the values described herein. In the appended Examples, the amount of the metal element Sn is 60 ppm.

In some embodiments of the present application, the metal element is Ge, and the amount of Ge in the polyester based on the total weight of the polyester is 100 ppm to 400 ppm, more specifically 150 ppm to 300 ppm. For example, based on the total weight of the polyester, the amount of Ge in the polyester can be 155 ppm, 160 ppm, 165 ppm, 170 ppm, 175 ppm, 180 ppm, 185 ppm, 190 ppm, 195 ppm, 200 ppm, 205 ppm, 210 ppm, 215 ppm, 220 ppm, 225 ppm, 230 ppm, 235 ppm, 240 ppm, 245 ppm, 250 ppm, 255 ppm, 260 ppm, 265 ppm, 270 ppm, 275 ppm, 280 ppm, 285 ppm, 290 ppm, or 295 ppm, or within a range between any two of the values described herein.

In some embodiments of the present application, the metal element is Ti, and the amount of Ti in the polyester based on the total weight of the polyester is 5 ppm to 100 ppm, more specifically 10 ppm to 50 ppm. For example, based on the total weight of the polyester, the amount of Ti in the polyester can be 11 ppm, 12 ppm, 13 ppm, 14 ppm, 15 ppm, 20 ppm, 25 ppm, 30 ppm, 35 ppm, 40 ppm, or 45 ppm, or within a range between any two of the values described herein. In the appended Examples, the amount of the metal element Ti is 10 ppm to 15 ppm.

In some embodiments of the present application, the metal element is Sb, and the amount of Sb in the polyester based on the total weight of the polyester is 100 ppm to 400 ppm, more specifically 150 ppm to 300 ppm. For example, based on the total weight of the polyester, the amount of Sb in the polyester can be 155 ppm, 160 ppm, 165 ppm, 170 ppm, 175 ppm, 180 ppm, 185 ppm, 190 ppm, 195 ppm, 200 ppm, 205 ppm, 210 ppm, 215 ppm, 220 ppm, 225 ppm, 230 ppm, 235 ppm, 240 ppm, 245 ppm, 250 ppm, 255 ppm, 260 ppm, 265 ppm, 270 ppm, 275 ppm, 280 ppm, 285 ppm, 290 ppm, or 295 ppm, or within a range between any two of the values described herein. In the appended Examples, the amount of the metal element Sb is 200 ppm.

### 2. Method for Manufacturing Polyester

The present application also provides a method for manufacturing polyester, wherein the polyester can be manufactured by polymerizing a polyol component with a polybasic acid component under the presence of the aforementioned phosphorus and metal element, wherein the polyol component comprises tricyclodecane dimethanol and one or more optional polyols other than tricyclodecane dimethanol, wherein the polybasic acid component comprises one or more polybasic acids and wherein the polyol component has a carbonyl value of less than 0.15 mg KOH/g.

In some embodiments of the present application, the polyester is manufactured by subjecting a polyol component comprising tricyclodecane dimethanol and a polybasic acid component to esterification and condense polymerization reaction under the presence of the phosphorus and the metal element. Specifically, the method for manufacturing polyester of the present application may comprise the following steps: (a) mixing tricyclodecane dimethanol, the polybasic acid component, and other optional polyols to form a mixture; (b) heating the mixture under a suitable pressure condition to conduct an esterification reaction to form oligomers; and (c) heating the mixture containing the oligomers with vacuum pumping to remove unreacted monomers to conduct a condensation reaction of the oligomers in the mixture and thus obtain the polyester of the present application, wherein a component containing the aforementioned metal element can be added in step (a), (b) or (c) and a component containing phosphorus can be added in step (a), (b) or (c).

In the aforementioned reactions, the reaction temperature and pressure conditions are not particularly limited, and persons having ordinary skill in the art would be able to select suitable conditions based on the disclosure of the present specification as well as their ordinary skill. For example, in some embodiments of the present application, the reaction temperature in step (b) may be 220° C. to 270° C., the reaction pressure in step (b) may be 0 atm to 6 atm, preferably 0 atm to 4 atm, the reaction temperature in step (c) may be 250° C. to 300° C., and the reaction pressure in step (c) may be 3 torr or less, preferably 1 torr or less.

In the aforementioned reactions, the polyol component comprising tricyclodecane dimethanol and other optional polyols has a carbonyl value of less than 0.15 mg KOH/g, preferably less than 0.03 mg KOH/g, and more preferably 0 mg KOH/g (i.e., a carbonyl value that is not detectable to the equipment). The carbonyl value can be achieved by subjecting the reactants to a purification step before polymerization reaction. Examples of the purification step include the following methods.

Method I: Preparing a fixed bed equipped with circulating pipes and a circulating pump, and filling the fixed bed with a transition metal type hydrogenation catalyst, preferably VIIIB type hydrogenation catalyst, and more preferably a catalyst comprising the transition metal of Ni, Pd, Rh, or Pt; after that, directing hydrogen into the fixed bed, and pumping the polyol component to be purified into the circulating pipes to repeat cyclic hydrogenation, wherein the backpressure of the system is preferably 5 bar to 100 bar, more preferably 10 bar to 30 bar, and the temperature of the system is preferably 0° C. to 200° C., more preferably 60° C. to 150° C.

Method II: Adding the polyol component to be purified into a round-bottom flask, and adding thereinto 1 ppm to 1,000 ppm, preferably 10 ppm to 100 ppm of paratoluenesulfonic acid (PTSA) based on the total weight of the polyol component; after raising the temperature to 80° C. and continuously stirring for 30 minutes, adjusting the pressure of the system to 2 torr to 10 torr by vacuum pumping and raising the temperature to the boiling point of the polyol component to make the polyol component be distilled out of the system. For example, TCDDM can be distilled out of the system at 172° C. to 180° C. and 2 torr.

Method III: Adding the polyol component to be purified into a high-pressure autoclave with a catalyst added therein, wherein the catalyst is transition metal type catalyst, preferably VIIIB type catalyst, and more preferably a catalyst comprising the transition metal of Ni, Pd, Rh, or Pt, and the amount of the catalyst can be 10 ppm to 10,000 ppm, preferably 100 ppm to 5,000 ppm based on the total weight of the polyol component; after that, conducting a reaction under a pressure of 20 bar to 100 bar for 2 hours to 10 hours, such as 3 hours, to accomplish purification.

### 3. Examples

### 3.1. Testing Methods

The present application is further illustrated by the embodiments hereinafter, wherein the testing instruments and methods are as follows:

[Carbonyl Value Test]

The carbonyl value test is conducted by using an auto-titrator equipped with electrodes and a stirrer to calculate the amount of carbonyl groups per gram of the sample. The testing method comprises: adding 50 grams of sample into a beaker; adding 10 ml of 0.1 N Na₂OH.HCl into the beaker and stirring the resultant sample solution with a stirrer until the components of the solution are well mixed; then titrating the sample solution with 0.05 N KOH solution and recording the titration volume at the first equilibrium point (pH<5); and comparing the result with a blank titration and calculating the carbonyl value according to the following formula:

Carbonyl value (mg KOH/g)=((A−B)×N×56.11)/W

wherein A is the amount (unit: ml) of KOH solution used in the sample titration; B is the amount (unit: ml) of KOH solution used in the blank titration; N is the equivalent concentration (i.e., normality) of the KOH solution; and W is the weight of the sample (unit: gram).

[Viscosity Test]

The prepared polyester is subjecting to the viscosity test according to ASTM D4603 and the viscosity is recorded as IV (Inherent Viscosity). The lower the IV value, the lower the molecular weight of the polyester.

[Measurements of the Amounts of Phosphorus and Metal Element]

The amounts of the phosphorus and the metal element are measured by an inductively coupled plasma optical emission spectrometer (ICP-OES) according to US EPA 3052 microwave digestion. In order to reach the accuracy of 1 mg/kg, a calibration curve is made using a phosphorus standard and metal element standard before the measurements. The testing method comprises: cutting the prepared polyester into 2 mm×2 mm pieces and weighting 0.2 g of the cut polyester as the sample; adding the sample into a digestion vessel and adding 3 ml of HNO₃ (concentration: 70%), 9 ml of HCl (concentration: 31%), and 3 ml of HF (concentration: 40%) thereinto; placing the digestion vessel in a microwave digestion equipment to conduct digestion until the sample is completely dissolved; and then, after the digestion vessel is cooled to room temperature, quantitating the sample to 25 ml with pure water, and analyzing the amounts of phosphorus and the metal element with an inductively coupled plasma optical emission spectrometer.

[Yellowing Resistance Test]

The b* value in the Lab color space of the polyester is measured according to ASTM D6290 and the YI (yellow index) value of the polyester is measured according to ASTM D6290. The higher the b* value or YI value, the poorer the yellowing resistance of the polyester.

[Transmittance Test]

A 60 mm×60 mm×2 mm polyester sample is prepared by an injection molding device (injection molding machine V90, obtained from Year-Chance Machinery Co., Ltd., Taiwan). The total transmittance of the polyester sample is measured by a Nippon Denshoku NDH 5000 hazemeter and is recorded as T.T % value. The higher the T.T % value, the better the transmittance.

### 3.2. List of Raw Materials Used in Examples and Comparative Examples

TABLE 1
list of raw materials

| Raw materials | Descriptions |
|---|---|
| TCDDM | Polyol, tricyclodecane dimethanol |
| EG | Polyol, ethylene glycol |
| PTA | Polybasic acid, terephthalic acid |
| H₃PO₄ | Phosphorus(V) compound (concentration: 85 wt %) |
| H₂NaPO₄ | Phosphorus(V) compound |
| TMPA | Phosphorus(V) compound, trimethyl phosphate |
| AO 1178 | Phosphorus(III) compound, CAS No. 26523-78-4 |
| 2112 | Phosphorus(III) compound, CAS No. 31570-04-4 |
| PEPQ | Phosphorus(III) compound, CAS No. 119345-01-6 |
| PET-8T | Phosphorus(III) compound, CAS No. 3806-34-6 |
| PEP-36 | Phosphorus(III) compound, CAS No. 80693-00-1 |
| TBT | Titanium-containing compound, titanium butoxide |
| AQ5000 | Titanium-containing compound |
| BuSn(OOC₈H₁₅)₃ | Tin-containing compound, butyltin |
| | tris(2-ethylhexanoate) |
| Sb(OAc)₃ | Antimony-containing compound, antimony acetate |

### 3.3. Preparation and Properties of Polyester

### 3.3.1. Examples 1 to 5 and Comparative Examples 1 to 9: Preparation of Polyester

### Example 1

393 g of TCDDM, 279 g of EG, 830 g of PTA, 0.14 g of H₃PO₄, and 0.131 g of TBT were added into a high-pressure autoclave and evenly stirred at a stirring speed of 150 rpm to form a mixture. The polyol component in the resulting mixture has a carbonyl value of less than 0.03. After that, the pressure of the high-pressure autoclave was set at 4 atm and the temperature was raised slowly from room temperature to 220° C. for conducting an esterification reaction. After the amount of water generated by the esterification reaction reached 90% of the theoretical value of water, the temperature of the high-pressure autoclave was raised to 250° C. and vacuum pumping was conducted for 30 minutes. After that, the temperature of the high-pressure autoclave was maintained at 280° C. to conduct a condensation reaction. After the reaction was completed, the temperature of the high-pressure autoclave was lowered, and the polyester product was collected.

### Example 2

The preparation procedures of Example 1 were repeated to prepare polyester, except that H₃PO₄ was substituted by 0.143 g of H₂NaPO₄, and TBT was substituted by 0.376 g of BuSn(OOC₈H₁₅)₃.

### Example 3

The preparation procedures of Example 1 were repeated to prepare polyester, except that the amount of H₃PO₄ was adjusted to 0.092 g, and TBT was substituted by 0.604 g of Sb(OAc)₃.

### Example 4

The preparation procedures of Example 1 were repeated to prepare polyester, except that H₃PO₄ was substituted by 2.051 g of AO 1178.

### Example 5

The preparation procedures of Example 1 were repeated to prepare polyester, except that H₃PO₄ was substituted by 0.377 g of PEP-36, and the used polyol component has a carbonyl value of 0.11.

### Comparative Example 1

The preparation procedures of Example 1 were repeated to prepare polyester, except that TCDDM was not used, the amount of EG was adjusted to 403 g, and H₃PO₄ was substituted by 0.295 g of PEP-36.

### Comparative Example 2

The preparation procedures of Example 1 were repeated to prepare polyester, except that H₃PO₄ was not used, and the amount of TBT was adjusted to 0.087 g.

### Comparative Example 3

The preparation procedures of Example 3 were repeated to prepare polyester, except that H₃PO₄ was substituted by 0.048 g of H₂NaPO₄.

### Comparative Example 4

The preparation procedures of Example 1 were repeated to prepare polyester, except that the amount of H₃PO₄ was adjusted to 5 g, and TBT was substituted by 0.627 g of BuSn(OOC₈H₁₅)₃.

### Comparative Example 5

The preparation procedures of Example 1 were repeated to prepare polyester, except that H₃PO₄ was substituted by 1.256 g of PEP-36.

### Comparative Example 6

The preparation procedures of Example 5 were repeated to prepare polyester, except that PEP-36 was not used.

### Comparative Example 7

The preparation procedures of Example 1 were repeated to prepare polyester, except that H₃PO₄ was substituted by 0.126 g of PEP-36, and TBT was substituted by 0.302 g of Sb(OAc)₃.

### Comparative Example 8

The preparation procedures of Example 1 were repeated to prepare polyester, except that H₃PO₄ was substituted by 4.103 g od AO 1178, and TBT was substituted by 0.091 g of Sb(OAc)₃.

### Comparative Example 9

The preparation procedures of Example 3 were repeated to prepare polyester, except that the amount of Sb(OAc)₃ was adjusted to 1.207 g.

### 3.3.2. Examples 1 to 5 and Comparative Examples 1 to 9: Properties of Polyester

The properties of the polyester of Examples 1 to 5 and Comparative Examples 1 to 9, including the amount of phosphorus, the amount of the metal element, the weight ratio of phosphorus to the metal element (P/M ratio), the b* value, the YI value, the T.T % value, and the IV value, were tested according to the testing methods described above, and the results are tabulated in Table 2-1 and Table 2-2.

TABLE 2-1

| Polyester constitution | | | | | |
|---|---|---|---|---|---|
| and properties | Example 1 | Example 2 | Example 3 | Example 4 | Example 5 |
| Carbonyl value | <0.03 | <0.03 | <0.03 | <0.03 | 0.11 |
| of polyol | | | | | |
| component | | | | | |
| (mg KOH/g) | | | | | |
| Type of | Phosphorus(V) | Phosphorus(V) | Phosphorus(V) | Phosphorus(III) | Phosphorus(III) |
| phosphorus (P) | | | | | |
| Type of metal | Ti | Sn | Sb | Ti | Ti |
| element (M) | | | | | |
| Amount of | 27.2 | 28 | 18 | 69 | 28 |
| phosphorus | | | | | |
| (ppm) | | | | | |
| Amount of | 14.5 | 56 | 187 | 14.2 | 14.6 |
| metal element | | | | | |
| (ppm) | | | | | |
| P/M ratio | 1.88 | 0.5 | 0.1 | 4.86 | 1.92 |
| Polymerization | 186 | 210 | 206 | 265 | 190 |
| time (minute) | | | | | |
| b* | 4.10 | 5.65 | 3.01 | 4.06 | 10.39 |
| YI | 9.98 | 13.78 | 12.85 | 9.19 | 25.29 |
| T.T % | 90.25 | 90.9 | 89.1 | 90.2 | 89.9 |
| IV | 0.61 | 0.61 | 0.62 | 0.59 | 0.61 |

TABLE 2-2

| | Compar- | Compar- | Compar- | Compar- | Compar- | Compar- | Compar- | Compar- | Compar- |
|---|---|---|---|---|---|---|---|---|---|
| Polyester | ative | ative | ative | ative | ative | ative | ative | ative | ative |
| constitution and | Example | Example | Example | Example | Example | Example | Example | Example | Example |
| properties | 1 | 2 | 3 | 4 | 5 | 6 | 7 | 8 | 9 |
| Carbonyl | <0.03 | <0.03 | <0.03 | <0.03 | <0.03 | 0.11 | <0.03 | <0.03 | <0.03 |
| value of polyol | | | | | | | | | |
| component | | | | | | | | | |
| Type of | Phospho- | Phospho- | — | Phospho- | Phospho- | — | Phospho- | Phospho- | Phospho- |
| phosphorus (P) | rus (III) | rus (V) | | rus (V) | rus (III) | | rus (III) | rus (III) | rus (V) |
| Type of | Ti | Ti | Sb | Sn | Ti | Ti | Sb | Sb | Sb |
| metal element | | | | | | | | | |
| (M) | | | | | | | | | |
| Amount of | 29 | ND | 8.2 | 4.1 | 91 | ND | 9.1 | 146 | 18.5 |
| phosphorus | | | | | | | | | |
| (ppm) | | | | | | | | | |
| Amount of | 14.3 | 9.1 | 192 | 87 | 14.2 | 14.1 | 338 | 29 | 386 |
| metal element | | | | | | | | | |
| (ppm) | | | | | | | | | |
| P/M ratio | 2.02 | 0 | 0.04 | 0.047 | 6.4 | 0 | 0.027 | 5.03 | 0.04 |
| Polymerization | 222 | 153 | 206 | 161 | 275 | 179 | 153 | >300 | 142 |
| time (minute) | | | | | | | | | |
| b* | 11.9 | 6.95 | 5.12 | 7.16 | 4.36 | 16.80 | 6.1 | NA | 6.5 |
| YI | 28.47 | 17.16 | 16.58 | 17.25 | 10.17 | 43.13 | 14.3 | NA | 15.1 |
| T.T % | 88.7 | 89.1 | 86.1 | 89.6 | 90.1 | 87.9 | 74.0 | NA | 72.2 |
| IV | 0.64 | 0.61 | 0.60 | 0.61 | 0.54 | 0.63 | 0.65 | NA | 0.66 |

*ND means that it cannot be detected by the equipment, and NA means that it cannot be tested

As shown in Table 2-1 and Table 2-2, the polyester of the present application can be made within an appropriate polymerization time and has an appropriate molecular weight as well as good yellowing resistance and transmittance. Specifically, Examples 1 to 6 shows that polyester with excellent properties as mentioned above can be provided using different phosphorus-containing compounds (P) and metal element-containing compounds (M) as long as the P/M ratio is within the specified range of the present application. Comparative Example 1 shows that the polyester prepared without using TCDDM has poor yellowing resistance. Comparative Examples 2 to 4, 6 to 7 and 9 show that the polyester prepared using a P/M ratio lower than the specified range of the present application have poor yellowing resistance and transmittance. Comparative Examples 5 and 8 show that a P/M ratio higher than the specified range of the present application would hinder the polymerization of polyester, resulting in that the polyester cannot be successfully synthesized (Comparative Example 8) or the obtained polyester does not have an appropriate molecular weight (Comparative Example 5, the IV value is too low) and thus has poor strength.

### 3.3.3. Examples 6 to 12 and Comparative Examples 10 and 11: Preparation of Polyester

The polyester products of Examples 6 to 12 and Comparative Examples 10 and 11 were prepared using the same TCDDM, EG and PTA formulations, but the ratio and species of phosphorus and metal elements are adjusted as shown in Table 2-3 and Table 2-4. Specifically, each of the components were added into a high-pressure autoclave and stirred with a stirring speed of 250 rpm to form a mixture, and the polyol component in the mixture has a carbonyl value of less than 0.03. After that, the pressure of the high-pressure autoclave was set at 2 atm and the temperature was raised slowly from room temperature to 240° C. to conduct an esterification reaction. After the amount of water generated by the esterification reaction reaches 90% of the theoretical value for water, the temperature of the high-pressure autoclave was raised to 260° C. and vacuum pumping was conducted for 30 minutes. After that, the temperature of the high-pressure autoclave was maintained at 280° C. to conduct a condensation reaction. After the reaction was completed, the temperature of the high-pressure autoclave was lowered, and the polyester product was collected.

### 3.3.4. Examples 6 to 12 and Comparative Examples 10 and 11: Properties of Polyester

The properties of the polyester of the examples and comparative examples, including the weight ratio of phosphorus to the metal element (P/M ratio), b* value, YI value, and T.T % value, were tested according to the testing methods described above, and the results are tabulated in Table 2-3 and Table 2-4.

TABLE 2-3

| Polyester | | | | | | | |
|---|---|---|---|---|---|---|---|
| constitution and | Example | Example | Example | Example | Example | Example | Example |
| properties | 6 | 7 | 8 | 9 | 10 | 11 | 12 |
| Carbonyl value | <0.03 | <0.03 | <0.03 | <0.03 | <0.03 | <0.03 | <0.03 |
| of polyol | | | | | | | |
| component | | | | | | | |
| Type of | Phosphorus | Phosphorus | Phosphorus | Phosphorus | Phosphorus | Phosphorus | Phosphorus |
| phosphorus (P) | (III) | (III) | (III) | (III) | (III) | (V) | (V) |
| Type of metal | Ti | Ti | Ti | Ti | Ti | Ti | Ti |
| element (M) | | | | | | | |
| P/M ratio | 1.69 | 1.73 | 1.74 | 2.05 | 1.86 | 1.63 | 1.88 |
| Polymerization | 192 | 188 | 181 | 186 | 179 | 211 | 203 |
| time (minute) | | | | | | | |
| b* | 3.90 | 3.02 | 2.63 | 2.69 | 3.85 | 4.02 | 5.31 |
| YI | 7.89 | 6.99 | 5.99 | 6.67 | 7.79 | 9.01 | 13.03 |
| T.T % | 90.5 | 91.1 | 91.2 | 91.1 | 90.9 | 90.3 | 90.8 |

TABLE 2-4

| Polyester constitution | Comparative | Comparative |
|---|---|---|
| and properties | Example 10 | Example 11 |
| Carbonyl value of polyol | <0.03 | <0.03 |
| component (mg KOH/g) | | |
| Type of phosphorus (P) | Phosphorus(V) | Phosphorus(III) |
| Type of metal element (M) | Ti | Ti |
| P/M ratio | 7.46 | 6.96 |
| Polymerization time (minute) | 362 | 266 |
| b* | 4.63 | 4.10 |
| YI | 11.1 | 10.4 |
| T.T % | 84.3 | 90.2 |

As further shown in Table 2-3 and Table 2-4, in the cases where the P/M ratio is within the specified range of the present application, the polyester containing phosphorus(III) (Examples 6 to 10) have a more excellent yellowing resistance than the polyester containing phosphorus(V) (Examples 11 and 12). Furthermore, in the cases where the P/M ratio is not within the specified range of the present application, the polyester has poor yellowing resistance regardless of using phosphorus(V) (Comparative Example 10) or using phosphorus(III) (Comparative Example 11).

The above examples are used to illustrate the principle and efficacy of the present application and show the inventive features thereof. People skilled in this field may proceed with a variety of modifications and replacements based on the disclosures and suggestions of the invention as described. Therefore, the scope of protection of the present application is that as defined in the claims as appended.

What is claimed is:

1. A polyester, which comprises one or more repeating units derived from polyols and one or more repeating units derived from polybasic acids and contains phosphorus and a metal element, wherein the one or more repeating units derived from polyols include a repeating unit derived from tricyclodecane dimethanol, the weight ratio of the phosphorus to the metal element ranges from 0.05 to 5.00, and the metal element is selected from the group consisting of Ti, Sn, Sb, Ge, Mn, Zn, Ca, Co, Pb, Al, Zr, and combinations thereof.

2. The polyester of claim 1, wherein the amount of the repeating unit derived from tricyclodecane dimethanol is 10 mol % or more based on the total moles of the one or more repeating units derived from polyols.

3. The polyester of claim 1, wherein the phosphorus is phosphorus(III), phosphorus(V), or a combination thereof.

4. The polyester of claim 1, wherein the metal element is selected from the group consisting of Ti, Sn, Ge, Sb, and combinations thereof.

5. The polyester of claim 1, wherein the amount of the phosphorus is 3 ppm to 200 ppm based on the total weight of the polyester, and the amount of the metal element is 5 ppm to 500 ppm based on the total weight of the polyester.

6. The polyester of claim 1, wherein the one or more repeating units derived from polyols further comprises one or more repeating units represented by 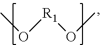
wherein R₁ is a C₂-C₁₇ linear or branched hydrocarbyl group.

7. The polyester of claim 2, wherein the one or more repeating units derived from polyols further comprises one or more repeating units represented by 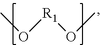
wherein R₁ is a C₂-C₁₇ linear or branched hydrocarbyl group.

8. The polyester of claim 3, wherein the one or more repeating units derived from polyols further comprises one or more repeating units represented by 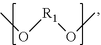
wherein R₁ is a C₂-C₁₇ linear or branched hydrocarbyl group.

9. The polyester of claim 4, wherein the one or more repeating units derived from polyols further comprises one or more repeating units represented by 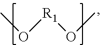
wherein R₁ is a C₂-C₁₇ linear or branched hydrocarbyl group.

10. The polyester of claim 5, wherein the one or more repeating units derived from polyols further comprises one or more repeating units represented by 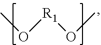
wherein R₁ is a C₂-C₁₇ linear or branched hydrocarbyl group.

11. The polyester of claim 1, wherein the one or more repeating units derived from polybasic acids are selected from the repeating units represented by 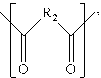
wherein R₂ is a C₄-C₁₆ hydrocarbyl group.

12. The polyester of claim 2, wherein the one or more repeating units derived from polybasic acids are selected from the repeating units represented by 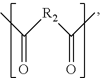
wherein R₂ is a C₄-C₁₆ hydrocarbyl group.

13. The polyester of claim 3, wherein the one or more repeating units derived from polybasic acids are selected from the repeating units represented by 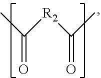
wherein R₂ is a C₄-C₁₆ hydrocarbyl group.

14. The polyester of claim 4, wherein the one or more repeating units derived from polybasic acids are selected from the repeating units represented by 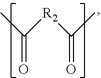
wherein R₂ is a C₄-C₁₆ hydrocarbyl group.

15. The polyester of claim 5, wherein the one or more repeating units derived from polybasic acids are selected from the repeating units represented by 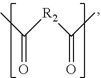
wherein R₂ is a C₄-C₁₆ hydrocarbyl group.

16. A method for manufacturing the polyester of claim 1, which comprises polymerizing a polyol component with a polybasic acid component under the presence of the phosphorus and the metal element, wherein the polyol component comprises tricyclodecane dimethanol and has a carbonyl value of less than 0.15 mg KOH/g.

17. The method of claim 16, wherein the amount of tricyclodecane dimethanol is 10 mol % or more based on the total moles of the polyol component.

18. The method of claim 16, wherein the phosphorus is phosphorus(III), phosphorus(V), or a combination thereof.

19. The method of claim 16, wherein the metal element is selected from the group consisting of Ti, Sn, Ge, Sb, and combinations thereof.
